(19) United States
(12) Patent Application Publication
(10) Pub. No.: US 2018/0056698 A1
(43) Pub. Date: Mar. 1, 2018

(54) ALUMINUM-MANGANESE-ZINC ALLOY

(71) Applicant: Novelis Inc., Atlanta, GA (US)

(72) Inventor: Jonathan Ball, Wootton Bridge (GB)

(73) Assignee: Novelis Inc., Atlanta, GA (US)

(21) Appl. No.: 15/689,219

(22) Filed: Aug. 29, 2017

Related U.S. Application Data
(60) Provisional application No. 62/382,321, filed on Sep. 1, 2016.

(51) Int. Cl. B41N 1/08; C22C 21/00; B41N 3/00

(52) U.S. Cl. CPC B41N 1/083; B41N 3/006; C22C 21/00

(57) ABSTRACT

Described herein are aluminum alloys, and methods of making the aluminum alloys, that are advantageous for use as lithographic printing plates. The aluminum alloys, and methods of making the aluminum alloys described herein provide lithographic printing plates without surface defects, but with the mechanical and physical properties currently demanded by the printing industry.

### CROSS REFERENCE TO RELATED APPLICATIONS

The present application claims the benefit of U.S. provisional patent application No. 62/382,321, entitled “Aluminum-Manganese-Zinc Alloy,” filed Sep. 1, 2016, which is hereby incorporated by reference in its entirety.

### TECHNICAL FIELD

The present disclosure relates to metallurgy generally and more specifically to aluminum alloy lithographic plates.

### BACKGROUND

Unless otherwise indicated herein, the materials described in this section are not prior art to the claims in this application and are not admitted to be prior art by inclusion in this section.

Aluminum alloy sheets are often employed as printing plates for roll-to-roll and sheet-fed printing techniques. Typical aluminum alloys used in printing applications do not meet the current demands of the industry, which include high strength, high bendability, and alloys free of microscopic defects. It is advantageous to control the surface condition of the rolled sheet to produce defect-free surfaces.

Aluminum alloy AA1050A has been used for lithographic printing plates. Larger plate formats, however, require better thermal resistance and more fatigue strength than alloy AA1050A provides. Approaches to increasing the strength of AA1050A include fabricating aluminum alloy sheets with increased amounts of magnesium (Mg) with or without manganese (Mn). One approach employed an Al, 0.2 weight percentage (wt. %) Mg alloy (see European patent number EP 1,065,071, entitled “Aluminum alloy strip used for making lithographic plate and method of production,” hereby incorporated by reference in its entirety) and another favored an Al, 0.1 wt. % Mg, 0.1 wt. % Mn alloy (see WIPO patent application number PCT/GB2001/005434, entitled “Aluminium alloy for lithographic sheet,” hereby incorporated by reference in its entirety).

Although these alloys generally have the mechanical properties demanded by lithographic printers, certain types of defects are commonly encountered during processing. For example, metal/metal oxide particles may be plucked out of the alloy surface during hot rolling and re-deposited in another location on the sheet, creating holes and rolled-in metal/metal oxide particles in the surface. On further rolling many of these survive to give defects in the surface. Attempts have been made to remove these particles chemically, (e.g., see European patent number EP 1,896,631, entitled “Conditioning of a litho strip,” hereby incorporated by reference in its entirety). A summary of the literature and examples of such metal/metal oxide defects can be found in G. Buytaert “Study of the (Sub) Surface on Rolled Commercially Pure Aluminium Alloys,” Ph. D. Thesis, Vrije Universiteit Brussel, Academic Year 2005-6.

There has long been a need in the industry for alloys having superior mechanical properties that also can be processed into lithographic printing plates without the significant defects currently plaguing the industry.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

Embodiments of the present disclosure include an aluminum alloy, including about 0.05-0.15 wt. % silicon (Si), about 0.3-0.5 wt. % iron (Fe), about 0.05-0.6 wt. % manganese (Mn), up to about 0.04 wt. % magnesium (Mg), about 0.01-0.5 wt. % zinc (Zn), up to about 0.04 wt. % titanium (Ti), up to about 0.01 wt. % chromium (Cr), up to about 0.04 wt. % copper (Cu), up to about 0.03 wt. % of impurities, and the remainder as aluminum (Al). In some non-limiting examples, Mn can be present in an amount of about 0.05-0.3 wt. %, about 0.05-0.15 wt. %, or about 0.05-0.09 wt. %. In some cases, Mg can be present in an amount of up to about 0.02 wt. %, or up to about 0.01 wt. %. In some examples, Zn can be present in an amount of about 0.05-0.25 wt. %, about 0.05-0.1 wt. %, or, e.g., at least about 0.02 wt. %.

Also disclosed herein is an aluminum alloy lithographic plate, including about 0.05-0.14 wt. % silicon (Si), about 0.07-0.1 wt. % iron (Fe), about 0.05-0.1 wt. % manganese (Mn), about 0.006-0.06 wt. % zinc (Zn), up to about 0.01 wt. % titanium (Ti), up to about 0.03 wt. % of impurities, and the remainder as aluminum (Al). In some examples, the aluminum alloy lithographic plate contains less than about 0.05 wt. % magnesium (Mg). In some non-limiting examples, the aluminum alloy lithographic plate has an ultimate tensile strength less than about 200 megaPascals (MPa). In some aspects, the aluminum alloy lithographic plate can have a surface devoid of Fe and/or Mg contaminants.

Also disclosed herein is an aluminum alloy lithographic plate, including about 0.05-0.14 wt. % silicon (Si), about 0.07-0.1 wt. % iron (Fe), about 0.05-0.1 wt. % manganese (Mn), about 0.006-0.06 wt. % zinc (Zn), up to about 0.01 wt. % titanium (Ti), up to about 0.03 wt. % of impurities, and the remainder as aluminum (Al), which is formed by a process including (i) providing a molten aluminum alloy composition, (ii) casting an aluminum alloy ingot from the molten aluminum alloy composition, (iii) scalping the aluminum alloy ingot to provide an aluminum alloy rolling ingot, (iv) homogenizing the aluminum alloy rolling ingot, (v) hot rolling the aluminum alloy rolling ingot to provide an intermediate gauge aluminum alloy rolled product, (vi) annealing the intermediate gauge aluminum alloy rolled product (i.e., interannealing or self-annealing during cooling), (vii) cold rolling the intermediate gauge aluminum alloy rolled product to provide a final gauge aluminum alloy rolled product, and (viii) cutting the final gauge aluminum alloy rolled product to provide an aluminum alloy lithographic plate blank. The aluminum alloy lithographic plate can include less than about 0.05 wt. % magnesium (Mg). The aluminum alloy lithographic plate can include Fe and Mg in a combined amount of less than about 0.11 wt. %, less than about 0.09 wt. %, or less than about 0.07 wt. %. In some non-limiting examples, the aluminum alloy lithographic plate can have a surface devoid of Fe and/or Mg contaminants. Homogenizing can include a one-stage homogenization or a two-stage homogenization.

### BRIEF DESCRIPTION OF THE DRAWINGS

The specification makes reference to the following appended figures, in which use of like reference numerals in different figures is intended to illustrate like or analogous components.

FIG. 1 is a graph of proof strength (PS) in MPa for alloys described herein in two metallurgical conditions.

FIG. 2 is a graph of yield strength in MPa for alloys described herein after various heat treatments.

FIG. 3 is a graph of ultimate tensile strength in MPa for alloys described herein after various heat treatments.

FIG. 4 is a graph of elongation in % for alloys described herein after various heat treatments.

### DETAILED DESCRIPTION

The subject matter of embodiments of the present invention is described here with specificity to meet statutory requirements, but this description is not necessarily intended to limit the scope of future claims. The subject matter to be claimed may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. The illustrative examples are given to introduce the reader to the general subject matter discussed herein and not intended to limit the scope of the disclosed concepts. The following sections describe various additional embodiments and examples with reference to the drawings in which like numerals indicate like elements and directional description are used to describe illustrative embodiments but, like the illustrative embodiments, should not be used to limit the present invention.

Unless indicated to the contrary, the numerical parameters set forth in the following specification are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety. It is further noted that, as used in this specification, the singular forms “a,” “an,” and “the” include plural referents unless expressly and unequivocally limited to one referent.

In this description, reference is made to alloys identified by aluminum industry designations, such as “series” or “AA1xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association. The following aluminum alloys are described in terms of their elemental composition in weight percentage (wt. %) based on the total weight of the alloy. In certain examples of each alloy, the remainder is aluminum, with a maximum wt. % of 0.15% for the sum of the impurities.

Reference is made in this application to alloy temper or condition. For an understanding of the alloy temper descriptions most commonly used, see “American National Standards (ANSI) H35 on Alloy and Temper Designation Systems.” An H1 condition or temper refers to an aluminum alloy after strain hardening. An H2 condition or temper refers to an aluminum alloy after strain hardening followed by partial annealing. An H3 condition or temper refers to an aluminum alloy after strain hardening and stabilization. A second digit following the HX condition or temper (e.g. H1X) indicates the final degree of strain hardening.

As used herein, terms such as “cast metal article,” “cast article,” and the like are interchangeable and refer to a product produced by direct chill casting (including direct chill co-casting) or semi-continuous casting, continuous casting (including, for example, by use of a twin belt caster, a twin roll caster, a block caster, or any other continuous caster), electromagnetic casting, hot top casting, or any other casting method.

As used herein, the term slab generally refers to an aluminum product having a thickness in a range of greater than approximately 15 mm to approximately 200 mm. For example, a slab may have a thickness of greater than about 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 105 mm, 110 mm, 115 mm, 120 mm, 125 mm, 130 mm, 135 mm, 140 mm, 145 mm, 150 mm, 155 mm, 160 mm, 165 mm, 170 mm, 175 mm, 180 mm, 185 mm, 190 mm, 195 mm, or 200 mm.

As used herein, the term plate generally refers to an aluminum product having a thickness in a range of 5 mm to 50 mm. For example, a plate may refer to an aluminum product having a thickness of about 5 mm, 10 mm, 15 mm, 20 mm, 25 mm, 30 mm, 35 mm, 40 mm, 45 mm, or 50 mm.

As used herein, the term sheet generally refers to an aluminum product having a thickness of less than about 4 mm. For example, a sheet may have a thickness of less than 4 mm, less than 3 mm, less than 2 mm, less than 1 mm, less than 0.5 mm, less than 0.3 mm, or less than 0.1 mm.

As used herein, the term foil generally refers to an aluminum product having a thickness less than 0.1 mm. For example, a foil can have a thickness of less than 0.1 mm, less than 0.09 mm, less than 0.08 mm, less than 0.07 mm, less than 0.06 mm, less than 0.05 mm, less than 0.04 mm, less than 0.03 mm, or less than 0.025 mm.

As used herein, the meaning of “room temperature” can include a temperature of from about 15° C. to about 30° C., for example about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., or about 30° C.

Described herein are aluminum alloys which exhibit the strength, formability, corrosion resistance, electrograinability, and surface condition advantageous for manufacture of lithographic printing plates and other uses. In non-limiting embodiments, the base alloy is a 1xxx series alloy.

### Aluminum Alloy Compositions

Embodiments of an aluminum alloy according to the present invention are set forth herein. Without limiting any of the foregoing embodiments, various embodiments of an aluminum alloy are set forth in the following table:

TABLE 1
Alloy Compositions

Optional Wt. %

| Element | Wt. % | Lower Limit | Upper Limit |
|---|---|---|---|
| Mn | 0.05-0.6% | 0.05 | 0.5 |
| | | | 0.45 |
| | | | 0.35 |
| | | | 0.30 |
| | | | 0.25 |
| | | | 0.15 |
| | | | 0.1 |
| | | | 0.09 |
| | | 0.10 | 0.5 |
| | | | 0.45 |
| | | | 0.35 |
| | | | 0.30 |
| | | | 0.25 |
| | | | 0.15 |
| Mg | ≦0.04 | | ≦0.03 |
| | | | ≦0.02 |
| | | | ≦0.01 |
| Zn | ≦0.5 | 0.01 | 0.5 |
| | | | 0.45 |
| | | | 0.35 |
| | | | 0.30 |
| | | | 0.25 |
| | | | 0.15 |
| | | | 0.1 |
| | | | 0.05 |
| | | 0.02 | 0.5 |
| | | | 0.45 |
| | | | 0.35 |
| | | | 0.30 |
| | | | 0.25 |
| | | | 0.15 |
| | | | 0.1 |
| | | | 0.05 |

| | |
|---|---|
| Al | Remainder |
| Impurities | Optionally, ≦0.01 each, ≦0.03 in total |

In some non-limiting examples, an aluminum alloy can have the composition set forth in the following table:

TABLE 2
Alloy Compositions

Optional Wt. %

| Element | Wt. % | Lower Limit | Upper Limit |
|---|---|---|---|
| Mn | 0.05-0.6% | 0.05 | 0.5 |
| | | | 0.45 |
| | | | 0.35 |
| | | | 0.30 |
| | | | 0.25 |
| | | | 0.15 |
| | | | 0.1 |
| | | | 0.09 |
| | | 0.10 | 0.5 |
| | | | 0.45 |
| | | | 0.35 |
| | | | 0.30 |
| | | | 0.25 |
| | | | 0.15 |
| Mg | ≦0.04 | | ≦0.03 |
| | | | ≦0.02 |
| | | | ≦0.01 |
| Zn | ≦0.5 | 0.01 | 0.5 |
| | | | 0.45 |
| | | | 0.35 |
| | | | 0.30 |
| | | | 0.25 |
| | | | 0.15 |
| | | | 0.1 |
| | | | 0.05 |
| | | 0.02 | 0.5 |
| | | | 0.45 |
| | | | 0.35 |
| | | | 0.30 |
| | | | 0.25 |
| | | | 0.15 |
| | | | 0.1 |
| | | | 0.05 |
| Fe (Iron) | 0.3-0.5 | 0.31 | 0.4 |

| | | |
|---|---|---|
| Si (Silicon) | 0.05-0.15 | — |
| Cr (Chromium) | ≦0.01 | — |
| Ti (Titanium) | ≦0.04 | — |
| Cu (Copper) | ≦0.04 | — |

| | |
|---|---|
| Al | Remainder |
| Impurities | Optionally, ≦0.01 each, ≦0.03 in total |

In certain examples, the alloy can include manganese (Mn) in an amount from about 0.05% to about 0.6% (e.g., from 0.05% to 0.18% or from 0.1% to 0.18%) based on the total weight of the alloy. For example, the alloy can include 0.05%, 0.051%, 0.052%, 0.053%, 0.054%, 0.055%, 0.056%, 0.057%, 0.058%, 0.059%, 0.06%, 0.061%, 0.062%, 0.063%, 0.064%, 0.065%, 0.066%, 0.067%, 0.068%, 0.069%, 0.07%, 0.071%, 0.072%, 0.073%, 0.074%, 0.075%, 0.076%, 0.077%, 0.078%, 0.079%, 0.08%, 0.081%, 0.082%, 0.083%, 0.084%, 0.085%, 0.086%, 0.087%, 0.088%, 0.089%, 0.09%, 0.091%, 0.092%, 0.093%, 0.094%, 0.095%, 0.096%, 0.097%, 0.098%, 0.099%, 0.1%, 0.11%, 0.12%, 0.13%, 0.14%, 0.15%, 0.16%, 0.17%, 0.18%, 0.19%, 0.2%, 0.21%, 0.22%, 0.23%, 0.24%, 0.25%, 0.26%, 0.27%, 0.28%, 0.29%, 0.3%, 0.31%, 0.32%, 0.33%, 0.34%, 0.35%, 0.36%, 0.37%, 0.38%, 0.39%, 0.4%, 0.41%, 0.42%, 0.43%, 0.44%, 0.45%, 0.46%, 0.47%, 0.48%, 0.49%, 0.5%, 0.51%, 0.52%, 0.53%, 0.54%, 0.55%, 0.56%, 0.57%, 0.58%, 0.59%, or 0.6% Mn. All expressed in wt. %.

In certain examples, the disclosed alloy includes magnesium (Mg) in an amount of up to about 0.04% based on the total weight of the alloy. For example, the alloys can include 0.01%, 0.02%, 0.03%, or 0.04% Mg. In some cases, the alloy does not include Mg (i.e., 0% Mg). All expressed in wt. %.

In certain aspects, the alloy described herein includes zinc (Zn) in an amount up to about 0.5% (e.g., from 0.001% to 0.09%, from 0.004% to 0.4%, from 0.03% to 0.5%, or from 0.06% to 0.1%) based on the total weight of the alloy. For example, the alloy can include 0.001%, 0.002%, 0.003%, 0.004%, 0.005%, 0.006%, 0.007%, 0.008%, 0.009%, 0.01%, 0.011%, 0.012%, 0.013%, 0.014%, 0.015%, 0.016%, 0.017%, 0.018%, 0.019%, 0.02%, 0.021%, 0.022%, 0.023%, 0.024%, 0.025%, 0.026%, 0.027%, 0.028%, 0.029%, 0.03%, 0.04%, 0.05%, 0.06%, 0.07%, 0.08%, 0.09%, 0.1%, 0.11%, 0.12%, 0.13%, 0.14%, 0.15%, 0.16%, 0.17%, 0.18%, 0.19%, 0.2%, 0.21%, 0.22%, 0.23%, 0.24%, 0.25%, 0.26%, 0.27%0.28%0.29%, 0.3%, 0.31%, 0.32%, 0.33%, 0.34%, 0.35%, 0.36%, 0.37%, 0.38%, 0.39%, 0.4%, 0.41%, 0.42%, 0.43%, 0.44%, 0.45%, 0.46%, 0.47%, 0.48%, 0.49%, or 0.5% Zn. All expressed in wt. %.

In certain aspects, the alloy also includes iron (Fe) in an amount from about 0.3% to about 0.5% (e.g., from 0.36% to about 0.49%, from 0.38% to 0.5%, from 0.47% to 0.49%, or from 0.33% to 0.44%) based on the total weight of the alloy. For example, the alloy can include 0.3%, 0.31%, 0.32%, 0.33%, 0.34%, 0.35%, 0.36%, 0.37%, 0.38%, 0.39%, 0.4%, 0.41%, 0.42%, 0.43%, 0.44%, 0.45%, 0.46%, 0.47%, 0.48%, 0.49%, or 0.5% Fe. All expressed in wt. %.

In certain examples, the disclosed alloy includes silicon (Si) in an amount from about 0.05% to about 0.15% (e.g., from 0.06% to 0.12%, from 0.05% to 0.1%, or from 0.075% to 0.125%) based on the total weight of the alloy. For example, the alloys can include 0.05%, 0.06%, 0.07%, 0.08%, 0.09%, 0.1%, 0.11%, 0.12%, 0.13%, 0.14%, or 0.15% Si. All expressed in wt. %.

In certain aspects, the alloy described herein includes chromium (Cr) in an amount up to about 0.01% (e.g., from 0.001% to 0.009%, from 0.004% to 0.008%, from or from 0.006% to 0.01%) based on the total weight of the alloy. For example, the alloy can include 0.001%, 0.002%, 0.003%, 0.004%, 0.005%, 0.006%, 0.007%, 0.008%, 0.009%, or 0.01% Cr. In some cases, Cr is not present in the alloy (i.e., 0% Cr).

In certain aspects, the alloy includes titanium (Ti) in an amount up to about 0.04% (e.g., from 0.01% to 0.04%) based on the total weight of the alloy. For example, the alloy can include 0.001%, 0.002%, 0.003%, 0.004%, 0.005%, 0.006%, 0.007%, 0.008%, 0.009%, 0.01%, 0.011%, 0.012%, 0.013%, 0.014%, 0.015%, 0.016%, 0.017%, 0.018%, 0.019%, 0.02%, 0.021%, 0.022%, 0.023%, 0.024%, 0.025%, 0.026%, 0.027%, 0.028%, 0.029%, 0.03%, 0.031%, 0.032%, 0.033%, 0.034%, 0.035%, 0.036%, 0.037%, 0.038%, 0.039%, or 0.04% Ti. In some cases, Ti is not present in the alloy (i.e., 0% Ti). All expressed in wt. %.

In certain aspects, the alloy includes copper (Cu) in an amount up to about 0.04% (e.g., from 0.01% to 0.04%) based on the total weight of the alloy. For example, the alloy can include 0.001%, 0.002%, 0.003%, 0.004%, 0.005%, 0.006%, 0.007%, 0.008%, 0.009%, 0.01%, 0.011%, 0.012%, 0.013%, 0.014%, 0.015%, 0.016%, 0.017%, 0.018%, 0.019%, 0.02%, 0.021%, 0.022%, 0.023%, 0.024%, 0.025%, 0.026%, 0.027%, 0.028%, 0.029%, 0.03%, 0.031%, 0.032%, 0.033%, 0.034%, 0.035%, 0.036%, 0.037%, 0.038%, 0.039%, or 0.04% Cu. In some cases, Cu is not present in the alloy (i.e., 0% Cu). All expressed in wt. %.

Optionally, the alloy compositions can further include other minor elements, sometimes referred to as impurities, in amounts of about 0.01% or below, 0.005% or below, or 0.001% or below, each. These impurities may include, but are not limited to, V, Ga, Ca, Ni, Sn, Hf, Sr, or combinations thereof. Accordingly, V, Ga, Ca, Ni, Sn, Hf, or Sr may be present in an alloy in amounts of 0.01% or below, 0.005% or below, or 0.001% or below. In certain aspects, the sum of all impurities does not exceed 0.03% (e.g., 0.01%). All expressed in wt. %. In certain aspects, the remaining percentage of the alloy is aluminum.

In some non-limiting examples, the aluminum alloy can have the composition set forth in the following table:

TABLE 3
Alloy Compositions

| Element | Weight Percentage (wt. %) |
|---|---|
| Si | 0.05-0.14 |
| Fe | 0.07-0.1 |
| Mn | 0.05-0.1 |
| Zn | 0.006-0.06 |
| Ti | 0.00-0.01 |
| Others | 0-0.01 (each) |
| | 0-0.03 (total) |
| Al | Remainder |

In certain examples, the disclosed alloy includes silicon (Si) in an amount from about 0.05% to about 0.14% (e.g., from 0.06% to 0.12%, from 0.05% to 0.1%, or from 0.075% to 0.125%) based on the total weight of the alloy. For example, the alloys can include 0.05%, 0.06%, 0.07%, 0.08%, 0.09%, 0.1%, 0.11%, 0.12%, 0.13%, or 0.14% Si. All expressed in wt. %.

In certain aspects, the alloy also includes iron (Fe) in an amount from about 0.07% to about 0.1% (e.g., from 0.075% to about 0.09%, from 0.08% to 0.1%, from 0.08% to 0.09%, or from 0.07% to 0.075%) based on the total weight of the alloy. For example, the alloy can include 0.07%, 0.08%, 0.09%, or 0.1% Fe. All expressed in wt. %.

In certain examples, the alloy can include manganese (Mn) in an amount from about 0.05% to about 0.1% (e.g., from 0.05% to 0.1% or from 0.07% to 0.09%) based on the total weight of the alloy. For example, the alloy can include 0.05%, 0.051%, 0.052%, 0.053%, 0.054%, 0.055%, 0.056%, 0.057%, 0.058%, 0.059%, 0.06%, 0.061%, 0.062%, 0.063%, 0.064%, 0.065%, 0.066%, 0.067%, 0.068%, 0.069%, 0.07%, 0.071%, 0.072%, 0.073%, 0.074%, 0.075%, 0.076%, 0.077%, 0.078%, 0.079%, 0.08%, 0.081%, 0.082%, 0.083%, 0.084%, 0.085%, 0.086%, 0.087%, 0.088%, 0.089%, 0.09%, 0.091%, 0.092%, 0.093%, 0.094%, 0.095%, 0.096%, 0.097%, 0.098%, 0.099%, or 0.1% Mn. All expressed in wt. %.

In certain aspects, the alloy described herein includes zinc (Zn) in an amount from about 0.006% to about 0.06% (e.g., from 0.006% to 0.01%, from 0.009% to 0.04%, from 0.03% to 0.05%, or from 0.01% to 0.04%) based on the total weight of the alloy. For example, the alloy can include 0.006%, 0.007%, 0.008%, 0.009%, 0.01%, 0.011%, 0.012%, 0.013%, 0.014%, 0.015%, 0.016%, 0.017%, 0.018%, 0.019%, 0.02%, 0.021%, 0.022%, 0.023%, 0.024%, 0.025%, 0.026%, 0.027%, 0.028%, 0.029%, 0.03%, 0.04%, 0.05%, or 0.06% Zn. All expressed in wt. %.

In certain aspects, the alloy includes titanium (Ti) in an amount up to about 0.01% (e.g., from 0.001% to 0.004%) based on the total weight of the alloy. For example, the alloy can include 0.001%, 0.002%, 0.003%, 0.004%, 0.005%, 0.006%, 0.007%, 0.008%, 0.009%, or 0.01% Ti. In some cases, Ti is not present in the alloy (i.e., 0% Ti). All expressed in wt. %.

Optionally, the alloy compositions can further include other minor elements, sometimes referred to as impurities, in amounts of about 0.01% or below, 0.005% or below, or 0.001% or below each. These impurities may include, but are not limited to, V, Ga, Ca, Ni, Sn, Hf, Sr, or combinations thereof. Accordingly, V, Ga, Ca, Ni, Sn, Hf, or Sr may be present in an alloy in amounts of 0.01% or below, 0.005% or below, or 0.001% or below. In certain aspects, the sum of all impurities does not exceed 0.03% (e.g., 0.01%). All expressed in wt. %. In certain aspects, the remaining percentage of the alloy is aluminum.

As will be appreciated from the description of the embodiments of the aluminum alloys described herein, the alloys have reduced Mg as compared to alloys currently used in the production of lithographic plates. In some aspects, at temperatures above 330° C. (e.g., at temperatures generally used for hot rolling aluminum alloys), Mg incorporated in aluminum alloys tends to become highly mobile. Mg can migrate to an outer surface of an aluminum alloy rolled article (e.g., an aluminum alloy sheet, an aluminum alloy foil, or an aluminum alloy plate) and can oxidize on the surface. Magnesium oxide (MgO) on the surface can cause surface defects when the aluminum alloy rolled article is processed into a lithographic printing plate. In some aspects, during hot rolling, MgO can adhere to steel rolls employed in hot rolling and can be extracted from the surface of the aluminum alloy rolled article at hot rolling temperatures when the aluminum alloy rolled article is soft. Consequently, any Mg and/or MgO adhering to the steel roll can be deposited back into the soft aluminum alloy rolled article as the roll rotates and any portion having extracted Mg and/or MgO contacts the soft aluminum alloy rolled article. Accordingly, any Mg and/or MgO on the surface during hot rolling can increase the number of holes and/or rolled-in metal (e.g., Mg) and/or metal oxide (e.g., MgO) defects in a final aluminum alloy rolled article. Such surface defects lead to detrimental results when aluminum alloy rolled articles (e.g., aluminum alloy sheets or lithographic plate blanks) are processed by electrograining. Briefly, the aluminum alloy sheets are electrograined by immersion in an acid solution (e.g., nitric acid) and exposure to an alternating current (AC) electric potential. In some non-limiting examples, the electrograining can controllably and uniformly pit the surface. The pits create a surface amenable to holding the necessary amount of liquid (e.g., fount solution) during, for example, printing, and promote adhesion of a developed light sensitive coating in an image area. Irregular pitting is a surface defect on the printing plate that can cause image loss through loss of adhesion. Irregular pitting can be caused by surface defects in the aluminum alloy rolled article caused during rolling as described above. Embodiments of aluminum alloy compositions of the present invention advantageously minimize these problematic issues.

### Methods of Producing Aluminum Alloy Lithographic Plates

An embodiment of an aluminum alloy composition described herein may be produced in the form of a sheet. Methods of producing an aluminum sheet are also described herein. In some examples, the method includes one or more steps of: providing a molten aluminum alloy; casting an ingot; optionally homogenizing the ingot; optionally hot rolling the homogenized ingot to produce a hot rolled intermediate product; cold rolling the hot rolled intermediate product to produce a cold rolled intermediate product; optionally interannealing the cold rolled intermediate product to produce an interannealed product; and cold rolling to a final gauge with a degree of cold work >60%.

The alloys described herein can be produced by various techniques, including, for example, the techniques described in commonly assigned International Publication No. WO 02/48415, entitled “Aluminium alloy for lithographic sheet,” the disclosure of which is hereby incorporated by reference.

Embodiments of aluminum alloys described herein can be cast into ingots using a direct chill (DC) process or cast into slabs using a continuous casting (CC) process. When using a DC process, the resulting ingots can optionally be scalped. The casting and scalping processes are performed according to standards commonly used in the aluminum industry as known to one of skill in the art. The ingot can then be subjected to further processing steps. In some examples, the processing steps further include a one-stage homogenization step or a two-stage homogenization step, a hot rolling step, a cold rolling step, an optional interannealing step, and a final cold rolling step.

The homogenization step described herein can be a single homogenization step (referred to as a “Type A preheat”) or a two-step homogenization process (referred to as a “Type C preheat”). In some non-limiting examples, the first homogenization step can dissolve metastable phases into an aluminum matrix and can minimize microstructural inhomogeneity. In some cases, an ingot is heated to attain a peak metal temperature of about 500-600° C. for a time period of about 1-24 hours. The heating rate to reach the peak metal temperature can be from about 50° C. per hour to about 100° C. per hour. In some examples, the ingot is then allowed to soak (i.e., maintained at the indicated temperature) for a period of time during the first homogenization stage. When a second homogenization step is used (e.g., Type C preheat), the ingot temperature is decreased to a temperature of from about 450° C. to 540° C. prior to subsequent processing. In some examples, the ingot temperature is decreased to a temperature of from about 480° C. to 540° C. prior to subsequent processing. For example, in the second stage the ingot can be cooled to a temperature of about 470° C., about 480° C., about 500° C., about 520° C., or about 540° C., and allowed to soak for a period of time. In some examples, the ingot is allowed to soak at the indicated temperature for up to 10 hours (e.g., from 30 minutes to 8 hours, inclusively). In some non-limiting examples, the Type C preheat can facilitate equilibration of solute atoms and provide a surface devoid of contaminants.

Following homogenization, a hot rolling step can be performed to provide an aluminum alloy sheet. The hot rolling step can include a hot reversing mill operation and/or a hot tandem mill operation. The hot rolling step can be performed at a temperature ranging from about 250° C. to about 540° C., in some embodiments from about 300° C. to about 500° C. In the hot rolling step, the ingots can be hot rolled to a thickness of 10 mm gauge or less (e.g., from 3 mm to 8 mm gauge). For example, the ingots can be hot rolled to a 8 mm gauge or less, 7 mm gauge or less, 6 mm gauge or less, 5 mm gauge or less, 4 mm gauge or less, or 3 mm gauge or less. Optionally, the hot rolling step can be performed for a period of up to one hour. Optionally, at the end of the hot rolling step (e.g., upon exit from the tandem mill), the aluminum alloy sheet can be coiled. Optionally, the aluminum alloy sheet can be allowed to self-anneal during cooling after the hot rolling step.

In some non-limiting examples, the hot rolled sheet can then undergo a cold rolling step. The cold rolling may be performed at a sheet temperature ranging from about 20° C. to about 200° C. (for example, from about 120° C. to about 200° C., or about 20° C., 30° C., 40° C., 50° C., 60° C., 70° C., 80° C., 90° C., 100° C., 110° C., 120° C., 130° C., 140° C., 150° C., 160° C., 170° C., 180° C., 190° C., 200° C., or anywhere in between). In certain examples, after hot rolling, a coil may be allowed to cool down to about room temperature (e.g., about 20° C.) before cold rolling. During cold rolling the temperature of the sheet may increase to about 200° C. The cold rolling step can be performed to a final gauge thickness of from about 0.5 mm to about 0.1 mm is achieved (e.g., 0.5 mm, 0.4 mm, 0.3 mm, 0.2 mm, 0.1 mm, or anywhere in between). Optionally, the aluminum alloy can undergo an interannealing step during cold rolling. For example, the aluminum alloy can be cold rolled to a first gauge thickness, interannealed, and further cold rolled to the final gauge thickness. The interannealing step can include heating the coil to a peak metal temperature of from about 300° C. to about 470° C. (e.g., about 300° C., 305° C., 310° C., 315° C., 320° C., 325° C., 330° C., 335° C., 340° C., 345° C., 350° C., 355° C., 360° C., 365° C., 370° C., 375° C., 380° C., 385° C., 390° C., 395° C., 400° C., 405° C., 410° C., 415° C., 420° C., 425° C., 430° C., 435° C., 440° C., 445° C., 450° C., 455° C., 460° C., 465° C., 470° C., or anywhere in between).

In some non-limiting examples, the aluminum alloys disclosed herein are advantageously suited for use as lithographic sheets. By way of example, after the foregoing steps are used to produce an aluminum alloy sheet, a lithographic sheet can be produced. Prior to shipment, the aluminum alloy sheet can be cleaned at a coil production facility according to cleaning methods commonly known in the art. Upon receipt at a lithographic plate making facility, the aluminum alloy sheet may be cleaned again. After cleaning, the alloy may be subjected to electrograining (e.g., in hydrochloric and/or nitric acid solutions), desmutting, anodizing, post treating with a chemical adhesion promoter, and/or application of a photosensitive coating. The aluminum alloy can then be cut into lithographic plates to be sent to a printer. At the printer, the lithographic plates may be exposed to develop the photosensitive coating, and optionally heat treated (i.e., stoved) to cure an image area. In some non-limiting examples, stoving can be performed at 240° C. for 10 minutes, 270° C. for 7 minutes, or 280° C. for 4 minutes to cure the photosensitive coating prior to printing.

In some non-limiting examples, electrograining can be performed by exposing the aluminum alloy to an AC electric potential in a nitric acid electrolyte, a hydrochloric acid electrolyte, or a combination thereof, until a total charge input of greater than 82 kC/m² is applied, and the surface of the aluminum alloy (i.e., lithographic sheet) obtains a pitted structure. Preferably, the total charge input is about 87 kC/m². The pitted structure can entirely cover the surface of the aluminum alloy and provide sufficient surface roughness to provide good adhesion of a photosensitive coating, good wear resistance, and good water retention after anodizing and post anodic treatment. The acid electrolyte solution may have a concentration of up to about 10% (e.g., about 0.5%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10.0%, or anywhere in between). The AC electric potential can be about 11 to about 40 volts (e.g., about 11 VAC, 12 VAC, 13 VAC, 14 VAC, 15 VAC, 16 VAC, 17 VAC, 18 VAC, 19 VAC, 20 VAC, 25 VAC, 30 VAC, 35 VAC, 40 VAC, or anywhere in between) and may be applied for 15-60 seconds (e.g., about 15 s, 20 s, 25 s, 30 s, 35 s, 40 s, 45 s, 50 s, 55 s, 60 s, or anywhere in between).

Reference has been made in detail to various embodiments of the disclosed subject matter, one or more examples of which are set forth above. Each embodiment was provided by way of explanation of the subject matter, not limitation thereof. In fact, it will be apparent to those skilled in the art that various modifications and variations may be made in the present subject matter without departing from the scope or spirit of the disclosure. For instance, features illustrated or described as part of one embodiment, may be used with another embodiment to yield a still further embodiment.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

### EXAMPLES

### Example 1: Effect of Alloy Composition on Electrograining

Alloy sheets having the compositions described in Table 4 below were prepared by methods disclosed herein. In addition to the listed elements, all alloy compositions contained 0.08% Si, 0.30% Fe, 0.006% Ti, about 0.001% Cu, about 0.001% Cr, about 0.001% Zr, and optionally include impurities in an amount of up to 0.05 each and up to 0.15 total, with the remainder as aluminum. Rolling ingots approximately 70 mm thick by 180 mm wide by 200 mm long were scalped from cast ingots cast in book molds. The rolling ingots were homogenized by heating from room temperature (e.g., from about 15° C. to about 30° C.) to 600° C. for a time period of 7.5 hours. The rolling ingots were soaked at 600° C. for 3 hours, and cooled for 2 hours to 500° C. and held for 10 hours at 500° C. to allow equilibration of solute to occur prior to hot rolling. This two-stage homogenization is referred to as a “Type C” preheat. Several samples were homogenized with a heat-to-roll practice (referred to as a “Type A” preheat) wherein the samples were subjected to ramped heating over a 12 hour period to a rolling temperature of 500° C. and held for 4 hours (total heating cycle about 16 hours).

The rolling ingots were hot rolled to an intermediate gauge of about 9 mm thickness and having a finish temperature of about 150° C., and allowed to air cool. Subsequent cold rolling to a final gauge of 0.3 mm was performed with an interannealing step performed when the gauge was reduced to about 2 mm. Interannealing was performed by heating to 450° C. and holding for 2 hours. After interannealing, the gauge was further reduced to 0.3 mm.

Samples were taken from the prepared alloys for further evaluation. Samples were cleaned in a 3% sodium hydroxide solution at 60° C. for 10 seconds and rinsed thoroughly with deionized (DI) water. The samples were then electrograined in a 1% nitric acid solution held at 40° C. The voltage applied was from 11 Volts AC (VAC) to 14 VAC (having a sine waveform) across a twin cell system operated in a liquid contact mode using impregnated graphite counter electrodes. The inter-electrode distance was 15 mm. Electrograining was performed for about 30 seconds and the total charge passed was about 87 kC/m². In some cases, these conditions can produce surfaces similar to those produced commercially using standard AA1050A aluminum alloys for lithographic applications.

The electrograined alloy samples were inspected by scanning electron microscopy (SEM). The visual assessment results were categorized as very good, good, acceptable, unacceptable, or poor as shown in Table 4.

TABLE 4
Electrograining performance of various AlMnMgZn Alloys

| | Elements | | | | | |
|---|---|---|---|---|---|---|
| Sample No. | Mn | Mg | Zn | Preheat | Rating | |
| 1 | 0 | 0 | 0.001 | A | + | Comparative |
| 2 | 0.1 | 0 | 0.001 | A | ++ | Example |
| 3 | 0.2 | 0 | 0.001 | A | ++ | Example |
| 4 | 0.05 | 0.05 | 0.001 | A | + | Comparative |
| 5 | 0.05 | 0.05 | 0.05 | A | + | Comparative |
| 6 | 0 | 0 | 0.006 | C | ++ | Comparative |
| 7 | 0.1 | 0 | 0.006 | C | ++ | Example |
| 8 | 0.1 | 0 | 0.02 | C | +++ | Example |
| 9 | 0.2 | 0 | 0.006 | C | ++ | Example |
| 10 | 0.2 | 0 | 0.02 | C | +++ | Example |
| 11 | 0.05 | 0 | 0.001 | C | ++ | Example |
| 12 | 0 | 0 | 0.001 | C | ++ | Comparative |
| 13 | 0.1 | 0.1 | 0.001 | A | ∘ | Comparative |
| 14 | 0.2 | 0.1 | 0.001 | A | ∘ | Comparative |
| 15 | 0.1 | 0.2 | 0.001 | A | ∘ | Comparative |
| 16 | 0.1 | 0.3 | 0.001 | A | ∘∘ | Comparative |

∘∘ = Poor,
∘ = Unacceptable,
+ = Acceptable,
++ = Good,
+++ = Very Good

In some cases, samples containing Mn without Mg exhibited an improved graining response over samples having a Mg content of 0.05% and greater (e.g., compare sample 2 to samples 13, 15, and 16; and compare sample 3 to sample 14). Exemplary samples that contained Mn without Mg (e.g., samples 2, 3, 7, 8, 9, 10, and 11) exhibited an improved graining response matching and/or surpassing the AA1050A standard. Additionally, comparative AA1050A samples exhibited a better graining response after being subjected to the Type C preheat (e.g., sample 6), than after being subjected to the Type A preheat (e.g., sample 1).

In some examples, adding Zn to the aluminum alloy further improved the graining response. In some aspects, adding low amounts of Zn (e.g., 0.006% or lower) had little effect on the graining response in samples containing Mn without Mg (e.g., compare sample 2 to sample 7; and compare sample 3 to sample 9). Surprisingly, adding increased amounts of Zn (e.g., from 0.02% to 0.05%) exhibited a further improved graining response in aluminum alloys containing Mn without Mg.

### Example 2: Effect of Alloy Composition and Processing on Proof Strength

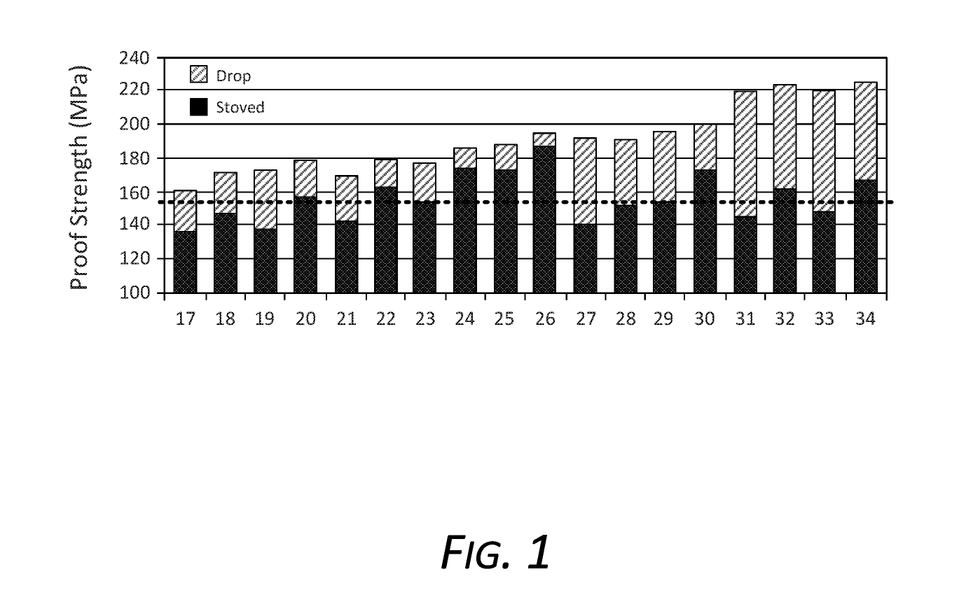

FIG. 1 is a graph showing proof strengths (y-axis, MPa) achieved with aluminum alloys having varying amounts of Mn and Mg, and subjected to various preheating procedures (e.g., Type A and Type C). Proof strength is shown before (hatched histogram, referred to as “drop”) and after (solid histogram, referred to as “stoved”) stoving (i.e., a heat treatment performed by an end user to harden an aluminum alloy lithographic plate image area). Table 5 below shows Mn and Mg composition and preheat type. All alloys were in the H19 condition. Target proof strength for a lithographic plate is 155 MPa (dashed horizontal line in FIG. 1). Surprisingly, an aluminum alloy having a composition including 0.05 wt. % Mn, 0 wt. % Mg, and subjected to the Type C preheat (sample 20) achieved the target proof strength. Evident in the graph, materials preheated according to Type A exhibited a much lower proof strength than aluminum alloys having the same composition and subjected to the Type C preheat. Materials containing Mg exhibited a larger drop in proof strength after stoving. AA1050A materials having been subjected to either the Type A or Type C preheat condition exhibited insufficient proof strengths (samples 17 and 18). Additionally, adding Zn to the aluminum alloy composition exhibited improved electrograining properties, however, no effect was observed on proof strength either before or after stoving, indicating that adding Zn improves electrograining and does not adversely affect the strength of the aluminum alloy.

TABLE 5
Various AlMnMg Alloys

| | Elements | | |
|---|---|---|---|
| Sample No. | Mn | Mg | Preheat |
| 17 | 0 | 0 | A |
| 18 | 0 | 0 | C |
| 19 | 0.05 | 0 | A |
| 20 | 0.05 | 0 | C |
| 21 | 0.1 | 0 | A |
| 22 | 0.1 | 0 | C |
| 23 | 0.2 | 0 | A |
| 24 | 0.2 | 0 | C |
| 25 | 0.5 | 0 | A |
| 26 | 0.5 | 0 | C |
| 27 | 0 | 0.05 | A |
| 28 | 0 | 0.05 | C |
| 29 | 0.1 | 0.05 | A |
| 30 | 0.1 | 0.05 | C |
| 31 | 0 | 0.2 | A |
| 32 | 0 | 0.2 | C |
| 33 | 0.04 | 0.2 | A |
| 34 | 0.04 | 0.2 | C |

### Example 3: Aluminum Alloy Lithographic Sheet Preparation and Testing

Six aluminum alloys were cast into ingots and prepared according to methods described below to provide alloy sheets having the compositions described in Table 6 below. In addition to the listed elements, all alloy compositions optionally contained impurities in an amount of up to 0.05 each and up to 0.15 total.

TABLE 6
Aluminum Alloy Lithographic Sheet Composition

Sample

| ID | | Si | Fe | Mn | Zn | Ti | Al |
|---|---|---|---|---|---|---|---|
| S313 | High | 0.0625 | 0.0794 | 0.05 | 0.0504 | 0.0092 | 99.7209 |
| | Zn | | | | | | |
| S314 | High | 0.0902 | 0.0825 | 0.0906 | 0.0499 | 0.0095 | 99.6494 |
| | Zn | | | | | | |
| S332 | Low | 0.1248 | 0.0838 | 0.0496 | 0.0203 | 0.0090 | 99.6882 |
| | Zn | | | | | | |
| S333 | Low | 0.1347 | 0.0897 | 0.0893 | 0.0208 | 0.0090 | 99.6325 |
| | Zn | | | | | | |
| S334 | Low | 0.1254 | 0.0944 | 0.0503 | 0.0066 | 0.0086 | 99.6871 |
| | Mn | | | | | | |
| S336 | High | 0.0571 | 0.0801 | 0.0895 | 0.0063 | 0.0083 | 99.7316 |
| | Mn | | | | | | |

The ingots were scalped to provide rolling ingots 40 mm thick. The rolling ingots were homogenized by heating to a temperature of 600° C. for a 7.5 hour period, held at 600° C. for 3 hours, then allowed to cool to 500° C. for a 2 hour period, and held at 500° C. for 3 hours. The ingots were then hot rolled to an intermediate gauge of 3.7 mm. Aluminum alloy samples S332, S333, S334, and S336 had a hot mill exit temperature of from 285° C.-292° C. after hot rolling. To simulate self-annealing that can occur in the coil after hot rolling (e.g., in a production scale operation), the samples were placed in a furnace at 340° C. which was then deactivated and allowed to cool for 24 hours. After simulated self-annealing, the samples were cold rolled to the gauges shown in Table 7 below. No interannealing was performed. All samples were provided in the H19 condition.

Mechanical properties of exemplary aluminum alloy samples S313, S314, S332, S333, S334, and S336 are shown in Table 7 for the as rolled condition (i.e., not heat treated) and after various heat treatments to simulate stoving, including heating at 240° C. for 10 minutes, heating at 270° C. for 7 minutes, and heating at 280° C. for 4 minutes. Evident in the table, all aluminum alloy samples exhibited strengths in an optimum range in the as rolled condition, having ample strength for aluminum alloy lithographic plate production and having ultimate tensile strengths less than 200 MPa. Having optimum strength can be beneficial for aluminum alloy lithographic plate production, wherein optimum strength aluminum alloys can provide uniform flatness in lithographic plates after an aluminum alloy coil is uncoiled. Also evident in Table 7, heat treating at 240° C. for 10 minutes provided strength values comparable to target strength values for a comparative AA3103 aluminum alloy used in lithographic plate production. AA3103 is a highly alloyed material (e.g., containing up to 0.7 wt. % Fe and up to 0.3 wt. % Mg for strength). The exemplary aluminum alloys provided herein exhibited comparable strength with low Fe content and no Mg content. Furthermore, wherein AA3103 can exhibit poor electrograining, all the exemplary aluminum alloys described herein exhibited good electrograining in nitric acid.

TABLE 7
Aluminum Alloy Lithographic Sheet Mechanical Properties

| | | | | | Ultimate | |
|---|---|---|---|---|---|---|
| Sam- | Heat Treatment | | | Yield | Tensile | |
| ple | Temperature | Time | Thickness | Strength | Strength | Elongation |
| ID | (° C.) | (min) | (mm) | (MPa) | (MPa) | (%) |
| S313 | 0 | 0 | 0.303 | 163 | 176 | 3.3 |
| S313 | 240 | 10 | 0.302 | 135 | 146 | 4.6 |
| S313 | 270 | 7 | 0.301 | 127 | 135 | 6.7 |
| S313 | 280 | 4 | 0.301 | 125 | 135 | 6.9 |
| S314 | 0 | 0 | 0.307 | 172 | 183 | 2.9 |
| S314 | 240 | 10 | 0.309 | 145 | 158 | 3.7 |
| S314 | 270 | 7 | 0.305 | 134 | 146 | 5.5 |
| S314 | 280 | 4 | 0.309 | 131 | 142 | 5.7 |
| S332 | 0 | 0 | 0.318 | 167 | 180 | 3.6 |
| S332 | 240 | 10 | 0.318 | 139 | 151 | 4.4 |
| S332 | 270 | 7 | 0.321 | 127 | 138 | 4.7 |
| S332 | 280 | 4 | 0.322 | 124 | 135 | 7.8 |
| S333 | 0 | 0 | 0.315 | 171 | 183 | 3.4 |
| S333 | 240 | 10 | 0.315 | 143 | 156 | 3.8 |
| S333 | 270 | 7 | 0.314 | 130 | 140 | 6.1 |
| S333 | 280 | 4 | 0.312 | 128 | 138 | 6.5 |
| S334 | 0 | 0 | 0.302 | 165 | 180 | 3.4 |
| S334 | 240 | 10 | 0.302 | 142 | 154 | 3.5 |
| S334 | 270 | 7 | 0.305 | 128 | 139 | 5.6 |
| S334 | 280 | 4 | 0.301 | 128 | 139 | 6.4 |
| S336 | 0 | 0 | 0.317 | 167 | 179 | 3.2 |
| S336 | 240 | 10 | 0.316 | 142 | 154 | 3.8 |
| S336 | 270 | 7 | 0.315 | 131 | 140 | 5.8 |
| S336 | 280 | 4 | 0.316 | 128 | 137 | 5.6 |

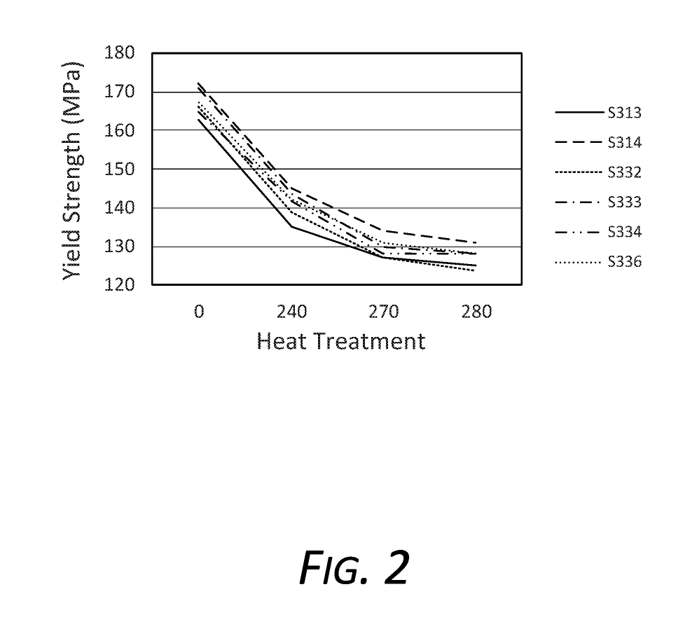

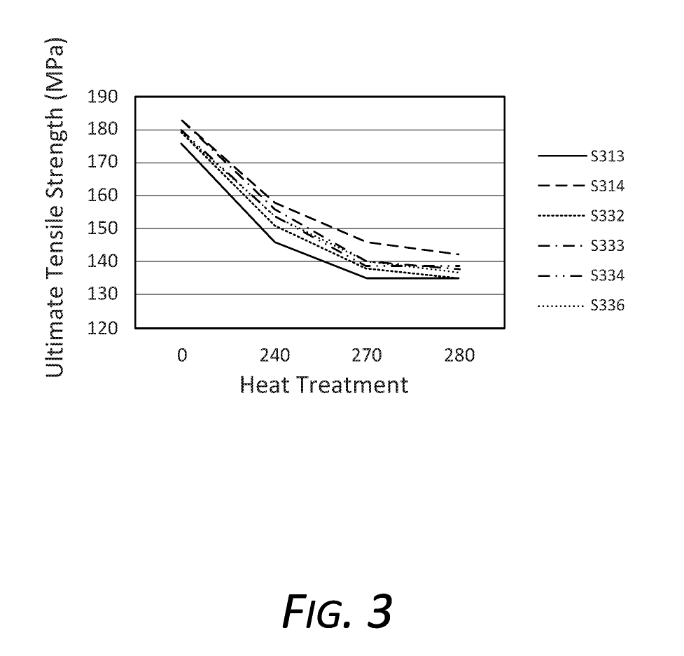

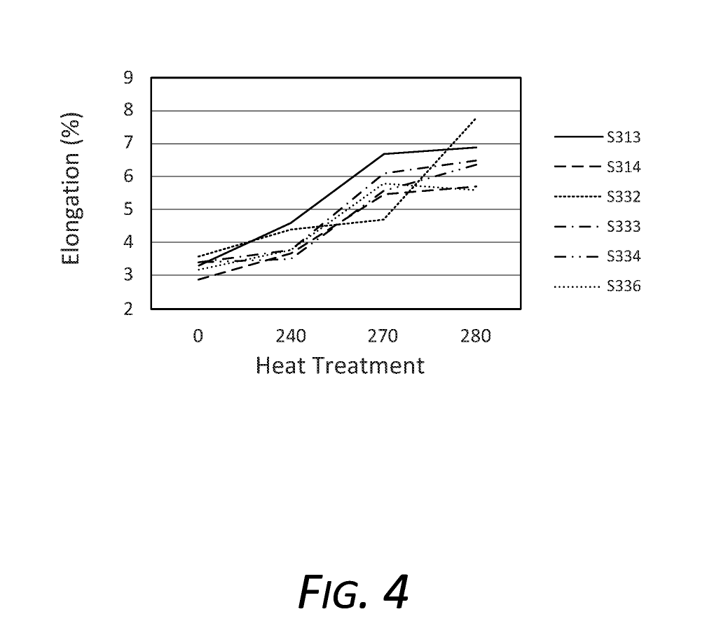

Mechanical properties of exemplary aluminum alloy samples S313, S314, S332, S333, S334, and S336 are shown in FIG. 2 (yield strength), FIG. 3 (ultimate tensile strength), and FIG. 4 (elongation). Alloy sample S313 is represented by a solid line, alloy sample S314 is represented by a dashed line, alloy sample S332 is represented by a small dashed line, alloy sample S333 is represented by a dashed-single dotted line, alloy sample S334 is represented by a dashed-double dotted line, and alloy sample S336 is represented by a dotted line in each figure. Evident in the graphs of FIG. 2 and FIG. 3, strength decreased as heat treatment temperature increased. Also evident in the graph of FIG. 4, elongation increased as heat treatment temperature increased.

What is claimed is:

1. An aluminum alloy, comprising:
about 0.05-0.15 wt. % silicon (Si);
about 0.3-0.5 wt. % iron (Fe);
about 0.05-0.6 wt. % manganese (Mn);
up to about 0.04 wt. % magnesium (Mg);
about 0.01-0.5 wt. % zinc (Zn);
up to about 0.04 wt. % titanium (Ti);
up to about 0.01 wt. % chromium (Cr);
up to about 0.04 wt. % copper (Cu);
up to about 0.03 wt. % of impurities; and
remainder as aluminum (Al).

2. The aluminum alloy of claim 1, wherein Mn is present in an amount of about 0.05-0.3 wt. %.

3. The aluminum alloy of claim 1, wherein Mn is present in an amount of about 0.05-0.15 wt. %.

4. The aluminum alloy of claim 1, wherein Mn is present in an amount of about 0.05-0.09 wt. %.

5. The aluminum alloy of claim 1, wherein Mg is present in an amount of up to about 0.02 wt. %.

6. The aluminum alloy of claim 1, wherein Mg is present in an amount of up to about 0.01 wt. %.

7. The aluminum alloy of claim 1, wherein Zn is present in an amount of about 0.05-0.25 wt. %.

8. The aluminum alloy of claim 1, wherein Zn is present in an amount of about 0.05-0.1 wt. %.

9. The aluminum alloy of claim 1, wherein Zn is present in an amount of at least about 0.02 wt. %.

10. An aluminum alloy lithographic plate, comprising:
about 0.05-0.14 wt. % silicon (Si);
about 0.07-0.1 wt. % iron (Fe);
about 0.05-0.1 wt. % manganese (Mn);
about 0.006-0.06 wt. % zinc (Zn);
up to about 0.01 wt. % titanium (Ti);
up to about 0.03 wt. % of impurities; and
the remainder as aluminum (Al).

11. The aluminum alloy lithographic plate of claim 10, further comprising less than about 0.05 wt. % magnesium (Mg).

12. The aluminum alloy lithographic plate of claim 10, wherein the aluminum alloy lithographic plate has an ultimate tensile strength less than about 200 megaPascals (MPa).

13. The aluminum alloy lithographic plate of claim 10, further comprising a surface devoid of contaminants selected from the group consisting of Fe and Mg.

14. An aluminum alloy lithographic plate, comprising: about 0.05-0.14 wt. % silicon (Si); about 0.07-0.1 wt. % iron (Fe); about 0.05-0.1 wt. % manganese (Mn); about 0.006-0.06 wt. % zinc (Zn); up to about 0.01 wt. % titanium (Ti); up to about 0.03 wt. % of impurities; and remainder as aluminum (Al); which is formed by a process comprising:
providing a molten aluminum alloy composition;
casting an aluminum alloy ingot from the molten aluminum alloy composition;
scalping the aluminum alloy ingot to provide an aluminum alloy rolling ingot;
homogenizing the aluminum alloy rolling ingot;
hot rolling the aluminum alloy rolling ingot to provide an intermediate gauge aluminum alloy rolled product;
annealing the intermediate gauge aluminum alloy rolled product;
cold rolling the intermediate gauge aluminum alloy rolled product to provide a final gauge aluminum alloy rolled product; and
cutting the final gauge aluminum alloy rolled product to provide an aluminum alloy lithographic plate blank.

15. The aluminum alloy lithographic plate of claim 14, further comprising less than about 0.05 wt. % magnesium (Mg).

16. The aluminum alloy lithographic plate of claim 14, wherein Fe and Mg are present in a combined amount of less than about 0.11 wt. %.

17. The aluminum alloy lithographic plate of claim 14, wherein Fe and Mg are present in a combined amount of less than about 0.09 wt. %.

18. The aluminum alloy lithographic plate of claim 14, wherein Fe and Mg are present in a combined amount of less than about 0.07 wt. %.

19. The aluminum alloy lithographic plate of claim 14, further comprising a surface devoid of contaminants selected from the group consisting of Fe and Mg.

20. The aluminum alloy lithographic plate of claim 14, wherein homogenizing the aluminum alloy rolling ingot comprises a one-stage homogenization or a two-stage homogenization.
